(19) United States
(12) Patent Application Publication
(10) Pub. No.: US 2004/0015960 A1
(43) Pub. Date: Jan. 22, 2004

(54) Method for loading and executing an application in an embedded environment

(76) Inventors: Sanjay Wanchoo, Lauderhill, FL (US); Jyh-Han Lin, Coral Springs, FL (US); Alex C. Wang, Plantation, FL (US); Alan W. Chan, Sunrise, FL (US); Ronald D. Smith, Coral Springs, FL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 09/811,332

(22) Filed: Mar. 16, 2001

(51) Int. Cl. G06F 9/445

(52) U.S. Cl. 717/178; 717/174; 713/2

(57) ABSTRACT

An embedded environment, such as that found in a portable communication device, has a non-volatile memory (106) for storing application files. The non-volatile memory includes sections designated as play areas (202) where applications are installed, and from which the application are executed. Upon installing an application, the physical addresses used by the application to call other portions of code, as well as the portions of code that may be called, are determined (308), and the application is written into the play area with the physical addresses, and executed from the play area.

### TECHNICAL FIELD

The invention relates in general to methods for invoking and executing applications, and more particularly to methods for invoking and executing applications in resource limited embedded systems.

### BACKGROUND OF THE INVENTION

There is a growing number of small, resource-limited computing devices available in the marketplace. These devices include such devices as cellular communication devices, personal digital assistants, so-called palm-top computers, and so on. Recently there has been an effort to have such devices connect to the Internet, and load and execute applications such as portable code applications or java applications. However, these embedded environments do not generally have the same level of computing resources such as random access memory (RAM), or complex, sophisticated file systems that ordinary general purpose computers have.

The limited resources of embedded environments present a problem when invoking applications in the devices. One problem that arises is how to load and execute applications, and where in the devices memory should the code reside during execution. There are two conventional approaches to this problem. First, the application could be loaded completely into RAM. Loading the application into RAM will require as much RAM as the size of the application file, and some additional RAM for variables and data structures. Typically, however, RAM is not provided in abundance in these kind of devices, which limits the usefulness of this approach. A second method is to execute the code while it resides in the file system. This requires the file system to be fairly sophisticated, and perform a significant amount of “housekeeping” such as updating pointers to classes. Again, because of the limited resources in embedded environments, this is not a desirable approach either. With either of these approaches there is a problem at runtime if the code has been moved, or if other code the application may call has been moved, as is common in managing applications in general purpose computers. This is because at runtime the linker has to update pointers used in calling other routines, data, and so on. Therefore there exists a need for a method of loading and executing applications without using excessive RAM, or requiting a sophisticated file management system.

### BRIEF DESCRIPTION OF THE DRAWINGS

FIG. 1 shows a block diagram of an embedded computing device:

FIG. 2 shows a memory diagram of a data structure organization in accordance with the invention; and

FIG. 3 shows a flow chart diagram of a method for loading and executing an application in an embedded system in accordance with the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. The invention solves the problem of RAM usage and runtime lag by installing the application in a non-volatile memory, and executing the application from the non-volatile memory. This has the additional benefit of leaving the application instantiated when the device is turned off, so that it doesn't need to be installed again upon turning the device on later.

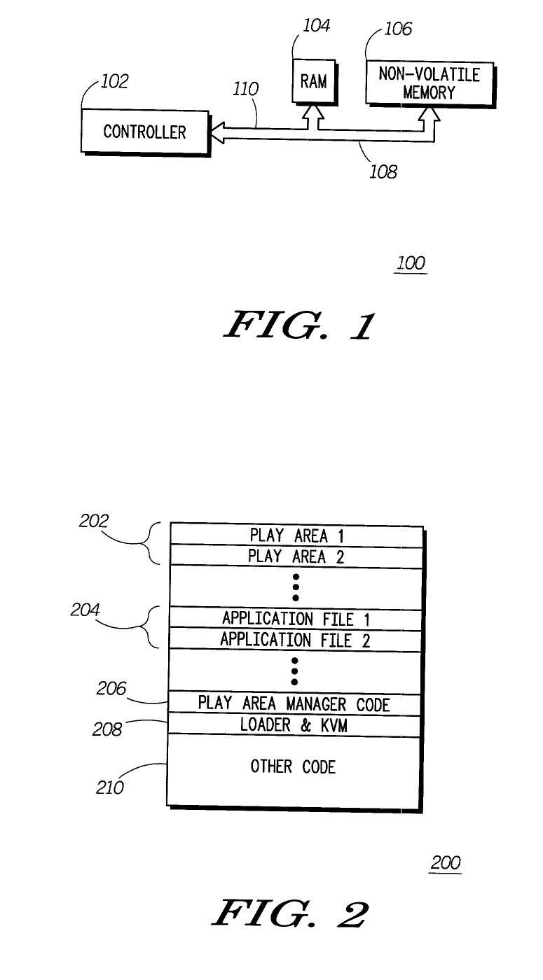

Referring now to FIG. 1, there is shown a block diagram of an embedded computing device 100. Specifically the block diagram shows only the controller 102 and two forms of memory, RAM 104 and non-volatile memory 106, connected to the controller over a bus 108. A chip select line 110 allows the controller to access either memory. Generally the controller is a microcontroller or microprocessor, as is common in the art. Likewise, the RAM 104 is conventional scratch pad memory. The non-volatile memory includes a portion of memory which is programmable. In the preferred embodiment, the non-volatile memory is a so-called flash memory. The non-volatile memory is used to store the executable code that operates the device, as well as data that the user wishes to store. Furthermore, in accordance with the invention, the non-volatile memory has a dedicated memory space for installing applications which are executed from the location in the non-volatile memory in which they are installed, as will be described hereinbelow.

Referring now to FIG. 2, there is shown a memory diagram 200 of a data structure organization in accordance with the invention. Section 202 represents memory space dedicated to play areas, where applications such as java applets and other portable code are installed, and reside until removed by the user or upon action of an application manager. The play area must be programmable by the device, and preferably erasable as well. Another section of the memory may be used for storing application files 204. Application files contain the compressed executable code, along with various files such as license files, descriptor files, and files used to authenticate the source of the application file for security purposes. In one embodiment of the invention, a play area manager 206 is used to manage the applications installed in the play areas. Since the memory space may be limited, and the user may wish to install more applications than for which there is space, the manager decides which application or applications can be uninstalled, or erased from memory so that the new application can be installed. The play area manager can be implemented with a user interface to allow the user to select which installed applications to delete, or it can be set up to be transparent to the user by, for example, keeping a record of the recency of use of the applications presently installed in the play area, and when a new application needs to be installed, the play area manager uninstalls the application with the oldest use. If the deleted application needs to be executed later, the play area manager simply erases the oldest-used application, and reinstalls the formerly deleted application. This requires the conventional run-time linking, but overall, there is a time savings by installing the applications in nonvolatile memory.

The installation, linking and execution is performed by code in the loader memory space 208. In the preferred embodiment the embedded environment is also provided with a means of executing portable code, such as a kJava virtual machine, or KVM, which can also reside in the loader memory space. The loader and KVM work in a conventional manner. Of course, the embedded environment also includes other code 210 to perform other functions, such as user interfaces, transceiver control, audio control, etc. One important application is a memory or media manager, such as a flash media manager (FMM), as is known in the art. The FMM controls low level memory operations as needed by other applications, algorithms, and routines. For example, the FMM performs the installation of an application in the play area, according the loader's instructions. Thus, the loader decides what it wants to do in memory, and the FMM carries out the instructions by managing the flash memory.

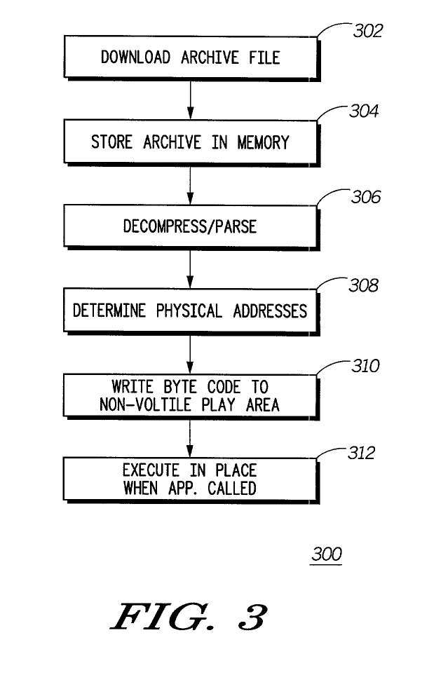

Referring now to FIG. 3, there is shown a flow chart diagram 300 of a method for loading and executing an application in an embedded system in accordance with the invention. To install and execute an application, the first step) is for the device to acquire an archive file (302). This can be accomplished by downloading, the archive file from a server over a network connection, such as an internet connection. In one embodiment, it is contemplated that the device is a portable communication device, such as an internet-enabled cellular phone or equivalent. Furthermore, the archive file may be, for example, a java archive file or JAR. Java specifications for mobile devices, such as mobile phone devices, are published, and therefore there are developers developing java applications to be used on such devices. However, the same is true for PDAs and other such devices. The archive file may also be loaded into the device by loading it over a local connection with, for example, a general purpose computer. A local connection can be made over a serial connection, such as RS-232.

As the device is acquiring the archive file, it must store it in memory (304). Storing the archive file in memory is performed by saving the file into the non-volatile memory 106. The process of downloading the archive file may also comprise authenticating the file for security purposes. If the archive file is a JAR, authentication is typically performed. After the archive file is acquired and stored, the file may sit idle until the user of the device decides to install the application contained in the archive file, or the application may be called by some other code. Whatever triggers the installation of the application so that it can be executed, the first thing done is decompressing the application. The application may be decompressed in RAM, or in the non-volatile storage, memory space permitting. The application code is then parsed. The parsing determines the logical addresses of the calls made by the application. In the preferred embodiment, the application is in byte code that is executable in a virtual machine environment, such as java. The parsing can be performed by a linker/loader application, as is known. However, a fundamental difference from other portable code environments is that the linker/loader, or equivalent application commences determining the physical addresses corresponding to the logical addresses determined during the parsing (308). This eliminates the need for what is referred to a “dereferencing.” It is also contemplated that, if the precise memory space where the application will be installed is known, such as a preselected play area memory space, the linker/loader can determine the physical addresses from the start, without having to first determine logical addresses. Determining the physical addresses eliminates the need to use pointers, and eliminates the need for dereferencing.

Once the physical addresses have been determined, the loader can commence writing the application code into one of the designated play areas (310). As installed, the application code contains physical addresses for calls made to various other portions of the code. This eliminates the need to update pointers, as is the practice when installing an application into RAM, where the contents of RAM are occasionally moved to accommodate other files and data structures. The use of non-volatile storage media along with the use of physical address eliminates the need to maintain pointers in a conventional fashion because the byte code is never moved once installed in the non-volatile memory. Furthermore, unlike when an application is installed in a virtual machine environment in RAM, installing the application in non-volatile memory allows the instantiation of the application to persist after the device is turned off, and there is no need to reinstall it upon turning the device on. When the application is executed, it is executed in place in the non-volatile memory. Executing the application in place (312) is done with the assistance of, for example, the FMM. An application may be executed upon an input by the user, or upon being called by another application or other software entity.

Thus the invention provides a method for loading and executing an application in an embedded environment. The method includes providing a pre-selected play area memory space in which to store the application in a non-volatile memory, and downloading an archive file containing a compressed version of the application. Typically the archive file is stored in the non-volatile memory in a storage space. When the application is to be installed, the embedded environment commences decompressing the compressed version of the application, and determining the physical addresses to be used by the application once it is installed in the play area memory space. Finally, writing the application with the corresponding physical addresses into the play area memory space is performed. Once the application is installed, the device may execute the application from the play area.

In the case of a portable communication device, such as a web-enabled cellular telephone, the invention provides a method for loading and installing a java application in the portable communication device. Similarly, in a portable communication device, the method includes providing a pre-selected play area memory space in which to store the application in a non-volatile memory of the portable communication device. Once the portable communication device is operating, a user can browse the Internet and find a suitable application and begin downloading a java archive (JAR) file from an internet server over the air interface between the portable communication device and the communication service infrastructure equipment, as is know in the art. The JAR file typically contains a compressed byte code version of the application and an authentication file, such as a digital certificate signed with the developer's public key. When the user decides to install the application, the portable communication device commences decompressing the compressed version of the application to obtain application byte code. At some tine during the process, the portable communication device also commences authenticating the JAR file using the authentication file. Prior to writing the byte code into the play area, the portable communication device goes about determining the physical addresses to be used by the application once it is installed in the play area memory space, and then writing the application byte code with the corresponding physical addresses into the play area memory space. Upon invoking the application, the application is executed from the play area utilizing a java virtual machine environment.

Therefore the invention avoids the problems of the conventional methods of installing and executing applications by loading the application into a designated or preselected non-volatile memory space, using physical addresses as opposed to pointers, and executing the application code from the non-volatile memory. This technique allows the application to persist in memory, allowing the application to be called without going through the process of installing according to conventional methods. The instant invention is especially useful in java and other portable code environments for those reasons.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for loading and executing an application in an embedded environment, comprising:
providing a pre-selected play area memory space in which to store the application in a non-volatile memory;
downloading an archive file, the archive file containing a compressed version of the application;
decompressing the compressed version of the application;
determining the physical addresses to be used by the application once it is installed in the play area memory space; and
writing the application with the corresponding physical addresses into the play area memory space.

2. A method for loading and executing an application in an embedded environment as defined in claim 1, wherein the step of providing comprises providing the pre-selected play area memory space in a flash memory.

3. A method for loading and executing an application in an embedded environment as defined in claim 1, further comprising executing the application from the play area memory space.

4. A method for loading and executing an application in an embedded environment as defined in claim 1, wherein the application is a java application in byte code form.

5. A method for loading and installing a java application in a portable communication device, comprising:
providing a pre-selected play area memory space in which to store the application in a non-volatile memory of the portable communication device;
downloading a java archive GAR) file from an internet server over an air interface, the JAR file containing a compressed byte code version of the application and an authentication file;
decompressing the compressed version of the application to obtain application byte code;
authenticating the JAR file using the authentication file;
determining the physical addresses to be used by the application once it is installed in the play area memory space; and
writing the application byte code with the corresponding physical addresses into the play area memory space.

6. A method for loading and installing a java application in a portable communication device as defined in claim 5, further comprising executing the application from the play area memory space utilizing a java virtual machine environment.

7. A method for loading and installing a java application in a portable communication device as defined in claim 5, wherein the step of providing comprises providing the pre-selected play area memory space in a flash memory.

8. A method for loading and executing an application in an embedded environment, comprising:
providing a pre-selected play area memory space in which to store the application in a non-volatile memory;
downloading the application from an internet server;
storing the application in a storage memory space of the non-volatile memory;
determining the physical addresses to be used by the application once it is installed in the play area memory space;
writing the application with the corresponding physical addresses into the play area memory space; and
executing the application from the play area memory space.

9. A method for loading and executing an application in an embedded environment as defined in claim 8, wherein the step of providing comprises providing the pre-selected play area memory space in a flash memory.

10. A method for loading and executing an application in an embedded environment as defined in claim 8, wherein the application is a java application in byte code form, the executing comprises executing the java byte code utilizing a java virtual machine environment.
